(19) United States
(12) Patent Application Publication
(10) Pub. No.: US 2008/0190783 A1
(43) Pub. Date: Aug. 14, 2008

(54) Electrode For Electrochemical Sensor

(75) Inventor: Mark Hyland, Yarnton (GB)

Correspondence Address: QUARLES & BRADY LLP, 411 E. WISCONSIN AVENUE, SUITE 2040, MILWAUKEE, WI, 53202-4497, US

(73) Assignee: OXFORD BIOSENSORS LIMITED, Yarnton (GB)

(21) Appl. No.: 11/630,459

(22) PCT Filed: Jun. 29, 2005
(86) PCT No.: PCT/GB05/02557

§ 371 Date: Dec. 21, 2006

(30) Foreign Application Priority Data
Jun. 29, 2004 (GB) 0414546.2

(51) Int. Cl. G01N 27/00

(52) U.S. Cl. 205/777.5; 204/403.14

(57) ABSTRACT

The invention concerns a device comprising an electrochemical cell. The device comprises a strip having a receptacle or partial receptacle formed therein. The working electrode of the electrochemical cell is in a wall of the receptacle or partial receptacle, and a pseudo reference electrode of the electrochemical cell is present as a layer on top of the surface of the strip. The device of the invention is useful in electrochemical sensing techniques.

### FIELD OF THE INVENTION

The present invention relates to a device comprising an electrochemical cell, typically comprising a microelectrode for electrochemical detection, a process for manufacturing such a device and an electrochemical sensing method employing the device.

### BACKGROUND TO THE INVENTION

Electrochemical cells containing microelectrodes are used for the electrochemical detection of various parameters of a substance. For example, such a cell may be used to detect, or measure the concentration of, a particular compound in a test substance. The use of electrochemical cells comprising microelectrodes as sampling devices brings a number of potential benefits including speed of operation, accuracy and minimal sample requirement. By using the microelectrodes in conjunction with enzymes or other electroactive substances it is possible to create sensors that provide quantitative measurement of target parameters through reactions with the corresponding electroactive substance.

An electrochemical cell which incorporates microelectrodes is described in WO 03/056319 (which document is hereby incorporated in its entirety by reference). The electrochemical cell described in this document comprises a well-like structure which incorporates the working electrode of the electrochemical cell in its walls. Typically, an enzyme or other electroactive substance is present in the well. The substance to be tested can be inserted into the well and, following reaction with the electroactive substance, electrochemical measurement carried out.

The cells described in WO 03/056319 also comprise a reference or pseudo reference electrode which is contained within the well-like structure. The described pseudo reference electrode can also act as the counter electrode and should therefore preferably have a greater surface area than the working electrode to ensure that the pseudo reference electrode does not influence the electrochemical response at the working electrode. However, if a large surface area of pseudo reference electrode is available within the well, it is highly probable that the electrode surface will come into contact with the electroactive substance. This can be detrimental to the electroactive substance, in particular where an enzyme is used since many materials employed as the counter and reference electrodes (e.g. Ag/AgCl) may cause enzymes to denature.

A further difficulty occurs when the reference/pseudo reference electrode is in the wall of the well. The well is typically formed by producing a laminate comprising any electrodes to be present in the wall, sandwiched between insulating layers. A hole is then punched or drilled or cut through the laminate to create the wall of the well. Where the reference/pseudo reference electrode is present in this laminate structure, the process of forming a hole in the laminate draws the electrode material down into the well, potentially causing electrode shorting or contamination of the interior of the well.

A new device is therefore required in which the area of the reference/pseudo reference electrode is maximised, whilst minimising contact between the reference/pseudo reference electrode and any electroactive substance.

### SUMMARY OF THE INVENTION

The present invention therefore provides a device comprising an electrochemical cell, said device comprising a strip having at least one receptacle or partial receptacle formed therein, the receptacle or partial receptacle having a first open part in a first surface of the strip to enable a sample to enter the receptacle or partial receptacle,
wherein a working electrode of the electrochemical cell is in a wall or walls of the receptacle or partial receptacle, and
wherein a pseudo reference electrode of the electrochemical cell comprises a pseudo reference electrode layer formed on at least a part of the first surface of the strip.

The device of the present invention comprises a strip containing a well-like structure having the working electrode of an electrochemical cell in its walls. A pseudo reference electrode is present in the form of a layer on top of the strip. The pseudo reference electrode is therefore not within the well itself, and will not contact any electroactive substance which is in the well. In this way, damage to the electroactive substance can be reduced or avoided.

Furthermore, the location of the pseudo reference electrode on top of the strip enables a large surface area of electrode to be used. The pseudo reference electrode therefore has a large current carrying capacity, which helps to avoid the cell current being limited by the pseudo reference electrode. The signal to noise ratio of the measurements may also be improved.

In a preferred embodiment of the invention, the pseudo reference electrode layer is not in contact with the perimeter of the first open part of the receptacle or partial receptacle. In this embodiment, even during insertion of the electroactive substance into the receptacle or partial receptacle, contact between the electroactive substance and the pseudo reference electrode layer is minimised.

In a further preferred embodiment, the pseudo reference electrode layer is close to the perimeter of the first open part of the receptacle or partial receptacle, for example no more than 0.5 mm from the perimeter. In this embodiment, both working electrode and counter electrode are typically wetted simply by filling a volume defined by the receptacle or partial receptacle and the edge of the pseudo reference electrode layer. Therefore, only a small volume of sample (if desired less than 1 μl) is usually required to wet both electrodes.

The present inventors have surprisingly found that the device of the invention also provides very reliable results when a membrane is placed over the receptacle. The inventors have found that where a membrane is located between the working and counter electrodes of a cell, poor results may be achieved, possibly due to the high resistance of the membrane to the passing of ionic current. This appears to cause a potential drop across the membrane itself, such that the potential between the working and counter electrodes cannot be reliably controlled. In the device of the present invention, a membrane can be placed over the receptacle and adhered, for example, to the surface of the strip or to the pseudo reference electrode layer. The working and pseudo reference electrodes are both accessible to the sample after it has passed through the membrane. Ionic current therefore does not need to pass through the membrane or through a thin layer of sample adjacent to the membrane. The potential between the working and pseudo reference electrodes can therefore be more reliably controlled.

Also provided is a process for producing a device according to the invention, which process comprises the steps of:
(a) forming a laminate comprising a working electrode layer between two layers of an insulating material;
(b) applying a pseudo reference electrode layer to at least a portion of a first surface of the laminate;
(c) creating a hole in the laminate; and optionally
(d) bonding a base to a second surface of said laminate to form a receptacle,
wherein step (b) is carried out before or after steps (c) and/or (d).

The process of the invention involves forming the receptacle by punching (or drilling or cutting) a hole in a laminate containing a working electrode layer. In one embodiment, the hole does not pass through the pseudo reference electrode layer that is located on a part of one surface of the laminate. Thus, the process of forming the hole does not cause contamination by drawing the pseudo reference electrode material down into the interior of the final receptacle. This, in turn, helps to reduce the possibility of electrode shorting.

The present invention further provides an electrochemical sensing method comprising
inserting a sample into the receptacle or partial receptacle of a device according to the invention;
applying a potential across the electrochemical cell; and
measuring the resulting electrochemical response.

### BRIEF DESCRIPTION OF THE FIGURES

FIG. 1 depicts a cross-sectional view of a device according to one embodiment of the invention;

FIG. 2 depicts a cross-sectional view of a device according to another embodiment of the invention;

FIG. 3 depicts a plan view of a device according to the invention; and

FIG. 4 illustrates a process for producing a device according to the invention.

### DETAILED DESCRIPTION OF THE INVENTION

As used herein, a pseudo reference electrode is an electrode that is capable of providing a reference potential. The pseudo reference electrode may also act as a counter electrode. In this case, the pseudo reference electrode is typically able to pass a current without substantially perturbing the reference potential. Alternatively, a separate counter electrode may be provided, in which case the pseudo reference electrode typically acts as a true reference electrode and is, for example, a standard hydrogen or calomel electrode.

As used herein, a receptacle is a component, for example a container, which is capable of containing a liquid placed into it. A partial receptacle is a component which forms a receptacle when placed onto a substrate. Thus, a partial receptacle when placed on a substrate is capable of containing a liquid.

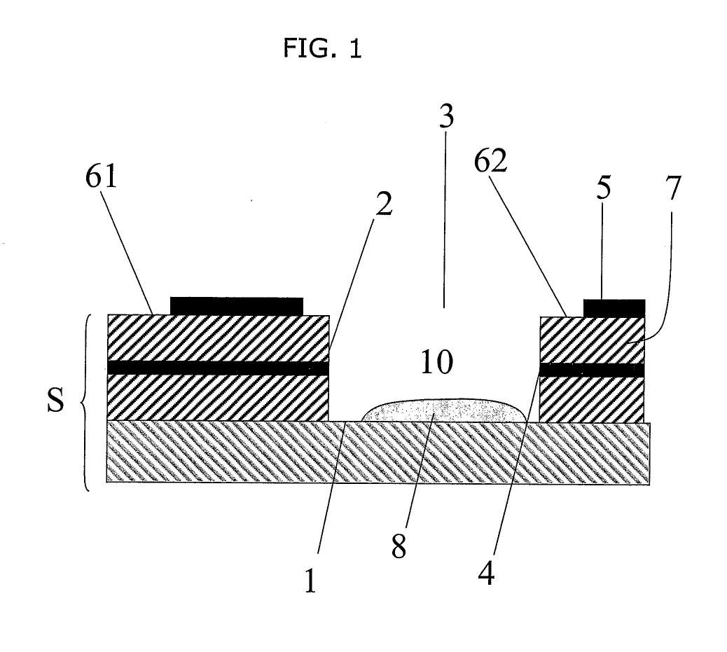

A first embodiment of the present invention is depicted in FIG. 1. In this embodiment, the device comprises a strip S. The strip S may have any shape and size, but typically has a first surface 61, 62 which is substantially flat. The device further comprises an electrochemical cell having a microelectrode. A microelectrode has at least one dimension not exceeding 50 μm. The microelectrodes of the invention may have a dimension which is macro in size, i.e. which is greater than 50 μm.

The strip comprises a receptacle 10 bounded by base 1 and wall or walls 2. The receptacle may be in any shape as long as it is capable of containing a liquid which is placed into it whilst the receptacle is placed on its base. For example, the receptacle may be substantially cylindrical. Generally, a receptacle will comprise a first open part 3, a base 1 and a wall or walls 2 which connect the first open part with the base. In one embodiment of the invention, the strip comprises a partial receptacle. In this embodiment, the strip is designed such that when placed against a separate substrate, the partial receptacle together with the substrate forms a receptacle. In this embodiment, the partial receptacle comprises a wall or walls 2 which connect the first open part 3 with a second open part. The second open part may be placed against the substrate to form a receptacle, such that the substrate forms the true base of the receptacle thus formed. Details of devices of this type can be obtained from WO 03/056319 (referenced above).

The receptacle typically has a width of from 0.1 to 5 mm, for example 0.5 to 2.0 mm, e.g. 0.5 to 1.5 mm, such as 1 mm. The width is defined as the maximum distance from wall to wall measured across the mid-point of the cross-section of the receptacle. In the case of a cylindrical receptacle, the width is the cross-sectional diameter.

The width of the receptacle may be substantially constant or it may be varying. For example, the wall(s) of the receptacle may slope, causing a varying width. An example of a receptacle having a varying width is a cone or truncated cone. In this case the width of the first open part is considered to be the width of the receptacle.

Typically, the receptacle will have a depth (i.e. from first open part to base) of from 25 to 1000 μm. In one embodiment, the depth is from 50 to 500 μm, for example from 100 to 250 μm. In an alternative embodiment, the depth is from 50 to 1000 μm, preferably from 200 to 800 μm, for example from 300 to 600 μm. The volume of the receptacle, as defined by the wall(s), the base and the first open part, is typically from 0.1 to 5 μl, for example from 0.1 to 3 μl or from 0.2 to 2 μl.

A working electrode 4 is situated in the wall(s) of the receptacle. The working electrode is, for example, in the form of a continuous band around the wall(s) of the receptacle. The thickness of the working electrode is typically from 0.01 to 25 μm, preferably from 0.05 to 15 μm, for example 0.1 to 20 μm, more preferably from 0.1 to 10 μm. Thicker working electrodes are also envisaged, for example electrodes having a thickness of from 0.1 to 50 μm, preferably from 5 to 20 μm. The thickness of the working electrode is its dimension in a vertical direction when the receptacle is placed on its base (i.e. the first open part is at the top). The area of the working electrode is thus typically no more than 5 mm², for example no more than 1 mm² or no more than 0.5 mm².

The working electrode is preferably formed from carbon, palladium, gold, platinum, silver or copper, in particular carbon, palladium, gold or platinum, for example in the form of a conductive ink. The conductive ink may be a modified ink containing additional materials, for example platinum and/or graphite. Two or more layers may be used to form the working electrode, the layers being formed of the same or different materials.

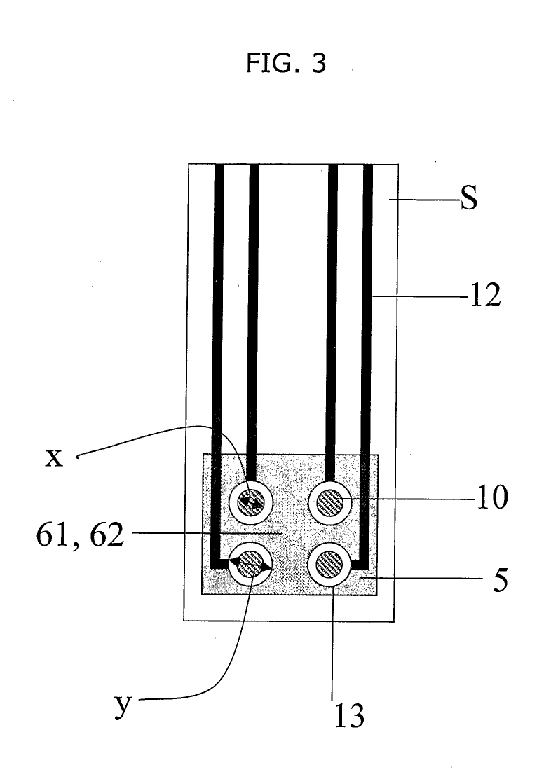

The pseudo reference electrode comprises a pseudo reference electrode layer 5 present on the first surface of the strip 61, 62. The first surface of the strip is an external surface, i.e. it is a surface exposed to the outside of the device rather than a surface exposed to the interior of the receptacle. Typically, as depicted in FIG. 3, the pseudo reference electrode layer substantially surrounds the receptacle or partial receptacle 10. As depicted in FIG. 1, it is preferred that the pseudo reference electrode layer is not in contact with the perimeter of the first open part 3. Typically, the pseudo reference electrode layer is at a distance of at least 0.1 mm, preferably at least 0.2 mm from the perimeter of the first open part. At least a part of the pseudo reference electrode is, however, typically no more than 2 mm, for example no more than 1 mm or 0.5 mm, preferably no more than 0.4 mm from the perimeter of the first open part. In one embodiment, the pseudo reference electrode substantially surrounds the receptacle or partial receptacle at a distance of from 0.01 to 1.0 mm, for example from 0.1 to 0.5 mm, or 0.2 to 0.4 mm from the perimeter of the first open part. Alternatively, this distance may be from 0.01 to 0.3 mm or from 0.4 to 0.7 mm.

The thickness of the pseudo reference electrode layer is typically similar to or greater than the thickness of the working electrode. Suitable minimum thicknesses are 0.1 μm, for example 0.5, 1, 5 or 10 μm. Suitable maximum thicknesses are 50 μm, for example 20 or 15μm. The thickness of the pseudo reference electrode layer is its dimension in a vertical direction when the receptacle is placed on its base (i.e. the first open part is at the top).

The pseudo reference electrode 5 typically has a surface area which is of a similar size to, or which is larger than, for example substantially larger than, that of the working electrode 4. Typically, the ratio of the surface area of the pseudo reference electrode to that of the working electrode is at least 1:1, for example at least 2:1 or at least 3:1 preferably at least 4:1. The pseudo reference electrode may, for example, be a macroelectrode. Where the ratio of the surface area of the pseudo reference electrode to that of the working electrode is greater than 1:1, this helps to ensure that the electrochemical reaction occurring at the pseudo reference electrode is not current-limiting. The actual area of the pseudo reference electrode is, for example, from 0.001 mm² to 150 mm², e.g. up to 100 mm² or from 0.1 mm² to 60 mm², for example from 1 mm² to 50 mm².

The pseudo reference electrode is typically made from Ag/AgSO₄, carbon, Ag/AgCl, palladium, gold, platinum, Hg/HgCl₂ or Hg/HgSO₄. It is preferably made from carbon, Ag/AgCl, palladium, gold, platinum, Hg/HgCl₂ or Hg/HgSO₄. Ag/AgCl is a preferred material. Each of these materials may be provided in the form of a conductive ink. The conductive ink may be a modified ink containing additional materials, for example platinum and/or graphite and/or an electrocatalyst (e.g. an enzyme) and/or a mediator. Examples of suitable electrocatalysts and mediators are described below with reference to the electroactive substance.

Preferred materials for use as the pseudo reference electrode are those which provide a constant potential drop at their surface, for example Ag/AgCl. It is further preferred that the electrochemically active components in the test solution are not oxidised/reduced at the pseudo reference electrode. This helps to prevent cycling of the electrochemically active components between the working and pseudo reference electrodes. Ag/AgCl pseudo reference electrodes are suitable for a number of electrochemical sensors.

In a further embodiment, the electrochemical cell may comprise a counter electrode in addition to the pseudo reference electrode. In the case that no separate counter electrode is present, the pseudo reference electrode acts as the counter electrode. Where a separate counter electrode is present, this may be located either within the receptacle or on the surface of the strip as desired. The counter electrode is typically made from Ag/AgSO₄, carbon, Ag/AgCl, palladium, gold, platinum, Hg/HgCl₂ or Hg/HgSO₄. It is preferably made from carbon, Ag/AgCl, palladium, gold, platinum, Hg/HgCl₂ or Hg/HgSO₄. Each of these materials may be provided in the form of a conductive ink. The conductive ink may be a modified ink containing additional materials, platinum and/or graphite and/or an electrocatalyst (e.g. an enzyme) and/or a mediator. Examples of suitable electrocatalysts and mediators are described below with reference to the electroactive substance.

In order that the cell can operate, the electrodes must each be separated by an insulating material 7. The insulating material is typically a polymer, for example, an acrylate, polyurethane, PET, polyolefin, polyester, PVC or any other stable insulating material. For example, the insulating material may be an acrylate, polyurethane, PET, polyolefin, or polyester. Polycarbonate and other plastics and ceramics are also suitable insulating materials. The insulating layer may be formed by solvent evaporation from a polymer solution. Liquids which harden after application may also be used, for example varnishes. Alternatively, cross-linkable polymer solutions may be used which are, for example, cross-linked by exposure to heat or UV or by mixing together the active parts of a two-component cross-linkable system. Dielectric inks may also be used to form insulating layers where appropriate. In an alternative embodiment, an insulating layer is laminated, for example thermally laminated, to the device.

The electrodes of the electrochemical cell may be connected to any required measuring instruments by any suitable means. Typically, the electrodes will be connected to electrically conducting tracks which are themselves connected to the required measuring instruments. The electrically conducting tracks may be made of any suitable conducting material, for example, carbon. In one embodiment of the invention, a metal coating, for example a silver coating, is applied underneath the carbon tracks in order to reduce the resistance of the tracks.

The receptacle may contain an electroactive substance 8. The electroactive substance 8 may be any substance which is capable of undergoing an electrochemical reaction when it comes into contact with a sample in an electrochemical cell. Thus, for example, on insertion of the sample into the cell and contact of the sample with the electroactive substance, an applied potential across the cell may cause an electrochemical reaction to occur and a measurable current to be produced.

The electroactive substance 8 comprises an electrocatalyst. Typically the electroactive substance 8 comprises an electrocatalyst and a mediator. A mediator is a chemical species that has two or more oxidation states of distinct electroactive potentials that allow a reversible mechanism of transferring electrons/charge to an electrode. The mediator reacts with the sample in the electrochemical reaction, the reaction being catalysed by the electrocatalyst.

Typical examples of an electrocatalyst are enzymes, for example lactate oxidase, cholesterol dehydrogenase, glycerol dehydrogenase, lactate dehydrogenase, glycerol kinase, glycerol-III-phosphate oxidase and cholesterol oxidase. Ionic species and metal ions, for example cobalt ions, may also be used as the electrocatalyst. Examples of suitable mediators are ferricyanide/ferrocyanide and ruthenium compounds such as ruthenium (III) hexamine salts (e.g. the chloride salt). Preferred examples of electroactive substances are those described in GB application no. 0414551.2 and the international application claiming priority therefrom (filed on the same day as the present application and entitled “ELECTROCHEMICAL SENSOR”), the contents of which are incorporated herein by reference in their entirety.

The electroactive substance 8 is typically inserted into the receptacle in such a position that the electroactive substance is not in contact with the pseudo reference electrode. The electroactive substance may be dried to ensure that it remains in position. The chances of contact occurring between the electroactive substance and the pseudo reference electrode, even during insertion of an electroactive substance in liquid form, are reduced further where the pseudo reference electrode is at a distance from the perimeter of the first open part of the receptacle.

The first open part of the receptacle may be partially covered by an impermeable material as long as at least part of the first open part is uncovered, or covered by a permeable or semi-permeable material, such as a permeable or semi-permeable membrane.

The receptacle may, in one embodiment, contain one or more further open parts. The further open parts typically take the form of small air-holes in the base or wall or walls of the receptacle (not depicted in FIG. 1). These holes allow air to escape from the receptacle when sample enters the receptacle. If no further open parts are present, the sample may not enter the receptacle when it flows over the open end, or it may enter the receptacle only with difficulty. The air holes typically have capillary dimensions, for example, they may have an approximate diameter of 1-600 μm, for example from 100 to 500 μm. The air holes should be sufficiently small that the sample is substantially prevented from leaving the receptacle through the air holes due to surface tension. Typically, one or more, e.g. from 1 to 4 air holes may be present.

In one embodiment of the invention, the base of receptacle is in the form of a porous hydrophobic or hydrophilic membrane. In this embodiment, the second open part is formed by the plurality of holes in the membrane. Appropriate porous membranes are known in the art, and Versapor™ by Pall is an example.

The device is useful in the electrochemical analysis of a sample, typically a liquid sample. Suitable samples include biological and non-biological substances including water, beer, wine, blood and urine samples. For the purposes of the present invention, the sample is the material which contacts the working electrode. In one embodiment, a specimen comprising the sample is supplied to the device of the invention. A filter, for example a filtration membrane, is positioned in the device such that the specimen is filtered prior to contacting the working electrode. For example, the specimen may be whole blood and a blood filtration membrane may be present which, for example, allows only plasma to pass through. In this case, the sample is plasma.

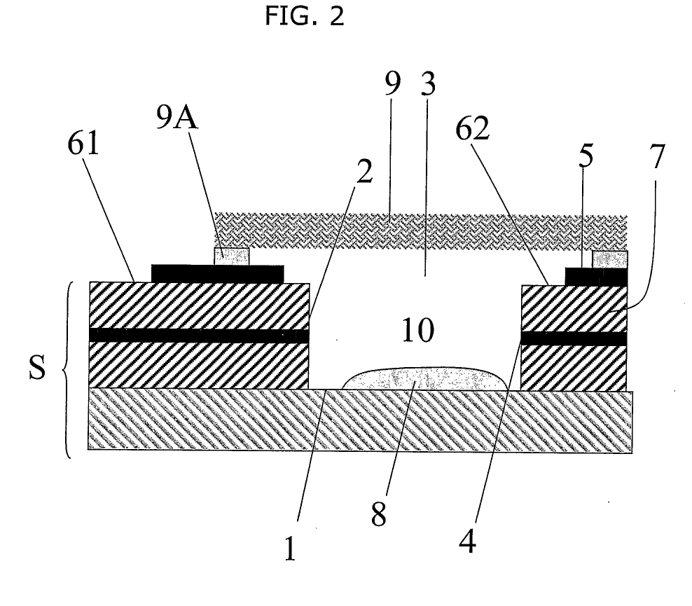

A further embodiment of the invention, which is the same as the first embodiment except as described below, is depicted in FIG. 2. In this embodiment, the first open part of the receptacle 3 is covered with a permeable or semi-permeable membrane 9. The membrane 9 serves to prevent dust or other contaminants from entering the receptacle, and helps to keep any electroactive substance which might be inserted into the receptacle in position.

Further, the use of a membrane covering the first open part of the receptacle essentially fixes the volume of sample which can enter the receptacle and react with the electroactive substance. The membrane also reduces the tendency of the electroactive substance to diffuse out of the receptacle once taken up by the sample. The membrane typically confines the electroactive substance within the volume defined by the receptacle and the membrane for a sufficient period of time to enable reaction with the sample, and electrochemical measurement, to take place. Therefore, the presence of the membrane enables the amount of electroactive substance available for reaction with the sample to be more precisely determined. This aspect of the invention is described in more detail in GB application no. 0414550.4 and the international application claiming priority therefrom (filed on the same day as the present application and entitled ELECTROCHEMICAL SENSING METHOD), the contents of which are incorporated herein by reference in their entirety.

The membrane 9 is preferably made of a material through which the sample to be tested can pass. For example, if the sample is plasma, the membrane should be permeable to plasma. The membrane also preferably has a low protein binding capacity. Suitable materials for use as the membrane include polyester, cellulose nitrate, polycarbonate, polysulfone, microporous polyethersulfone films, PET, cotton and nylon woven fabrics, coated glass fibres and polyacrylonitrile fabrics.

These fabrics may optionally undergo a hydrophilic or hydrophobic treatment prior to use. Other surface characteristics of the membrane may also be altered if desired. For example, treatments to modify the membrane's contact angle in water may be used in order to facilitate flow of the desired sample through the membrane. The membrane may comprise one, two or more layers of material, each of which may be the same or different, e.g. a composite of one or more membranes. For example, conventional double layer membranes comprising two layers of different membrane materials may be used.

The membrane may also be used to filter out some components which are not desired to enter the cell. For example, some blood products such as red blood cells or erythrocytes may be separated out in this manner such that these particles do not enter the cell. Suitable filtration membranes, including blood filtration membranes, are known in the art. Examples of blood filtration membranes are Presence 200 of Pall filtration, Whatman VF2, Whatman Cyclopore, Spectral NX, Spectral X and Pall BTS, e.g. Presence 200 of Pall filtration, Whatman VF2, Whatman Cyclopore, Spectral NX and Spectral X. Fibreglass filters, for example Whatman VF2, can separate plasma from whole blood and are suitable for use where a whole blood specimen is supplied to the device and the sample to be tested is plasma. An active membrane which removes LDL from the blood can also be used.

A spreading membrane may be used as an alternative to, or typically in addition to, a filtration membrane. Thus, for example, the membrane may be a composite of a spreading membrane and a filtration membrane, with the spreading membrane typically the outer membrane which will contact the specimen first. Appropriate spreading membranes are well known in the art and Petex is an example. In one embodiment, the membrane comprises a layer of a Petex membrane and a layer of a Pall BTS membrane.

The membrane may be attached to the device by any suitable attachment means 9A, for example using a double-sided adhesive tape. Typically, the attachment means attaches the membrane to the first surface of the strip or to the pseudo reference electrode layer. In a preferred embodiment as depicted in FIG. 2, the membrane is attached to the pseudo reference electrode layer 5 at a location which is remote from the perimeter of the receptacle itself. Further, the attachment means is at a greater distance from the first open part of the receptacle 3 than the pseudo reference electrode layer, such that at least a part of the surface of the pseudo reference electrode layer close to or surrounding the receptacle is exposed to a sample which has passed through the membrane. Preferably, the attachment means is at least 0.2 mm, for example at least 0.3 mm or at least 0.4 mm, from the perimeter of the receptacle.

In the embodiment depicted in FIG. 2, a reaction volume is defined by the receptacle base 1 and walls 2, part of the surface of the strip 61, 62, the pseudo reference electrode layer 5, the attachment means 9A and the membrane 9. This reaction volume can be varied by changing the volume of the receptacle, the position and thickness of the pseudo reference electrode layer and the position and thickness of the attachment means 9A. Preferred reaction volumes are at least 0.05 μl, for example at least 0.1 or at least 0.2 μl. It is further preferred that the reaction volume is no more than 25 μl, preferably no more than 5 μl, for example no more than 3 μl or no more than 2 μl.

In a further embodiment, the device may comprise one or more capillary channels to allow sample to enter the receptacle. Further details regarding a receptacle comprising such capillary channels can be derived from WO 03/056319 (referenced above).

In one embodiment, the invention relates to a device which comprises two or more receptacles. A device of this type is depicted in plan view in FIG. 3. The depicted device has four receptacles 10. Each receptacle typically has a working electrode and and preferably is a receptacle in accordance with the embodiments described above.

The device comprises a plate or strip S which comprises four electrochemical cells at each receptacle 10. Each receptacle may contain the same or different electroactive substances such that when a sample is inserted into each receptacle, several different tests may be carried out or the same test may be repeated several times in order to detect or eliminate errors in the measurements taken. Furthermore, a different potential may be applied across each cell, providing different measurements for the same sample.

Each receptacle comprises its own working electrode located in the walls of the receptacle. The pseudo reference electrode 5 for each receptacle may be formed by a single layer of pseudo reference electrode across the surface of the strip 61, 62. Alternatively, a separate layer of pseudo reference electrode may be present at each receptacle. The pseudo reference electrode layer typically surrounds each receptacle, leaving a blank area 13 between the perimeter of the receptacle and the edge of the pseudo reference electrode layer.

Each receptacle has a width x. Typically, the pseudo reference electrode layer does not contact the perimeter of the receptacle and the width y of the blank area 13 is therefore typically greater than the width x.

The receptacles are typically separated by a distance of from 0.5 to 10 mm, for example from 1 to 5 mm or from 2 to 4 mm.

The electrodes are connected to any required measuring instruments by electrical tracks 12. The tracks 12 are typically on the top surface of the device. Filled vias are used to connect the pseudo reference, optional separate counter and working electrodes to the surface tracks 12 which then mate with a measuring instrument.

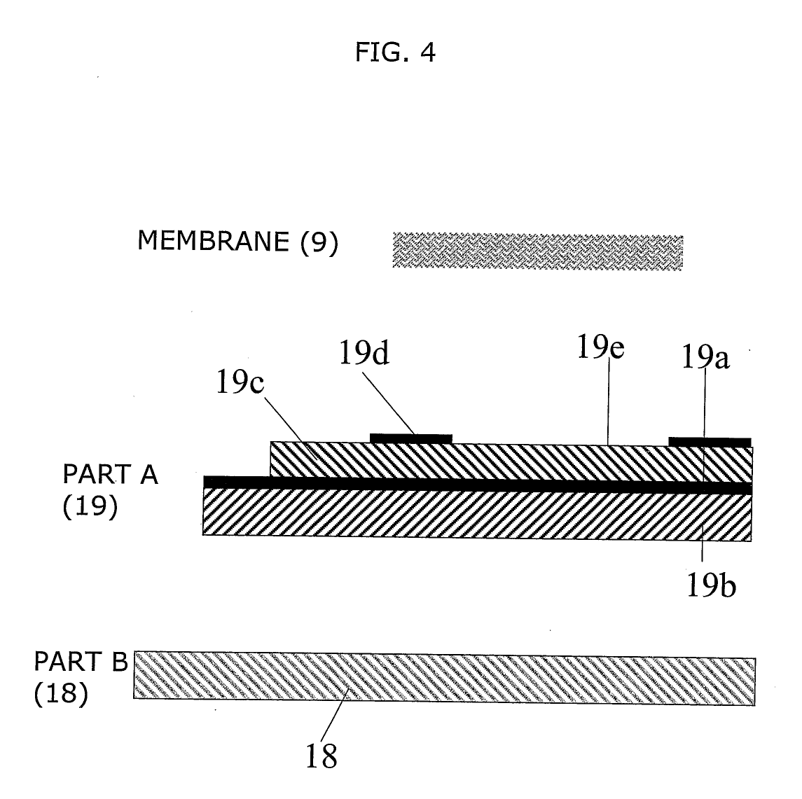

A process for producing the devices of the invention is depicted in FIG. 4. The process comprises forming a laminate 19 (Part A) comprising a working electrode layer 19a between two insulating layers 19b, 19c.

Carbon or other inks may, for example, be printed onto the insulating material 19b, 19c using a screen printing, ink jet printing, thermal transfer or lithographic or gravure printing technique, for example the techniques described in WO 02/076160 (the contents of which are incorporated herein in their entirety by reference). Two or more coatings which are formed of the same or different materials, may be applied, if desired. The insulating layer 19c may also be formed by printing an insulating material onto the working electrode layer. Other techniques for forming the insulating layer include solvent evaporation of a solution of the insulating material or formation of an insulating polymer by a cross-linking mechanism. Alternatively, the insulating layer may be formed by laminating, for example thermally laminating, a layer of insulating material to the working electrode layer 19a.

A pseudo reference electrode layer 19d is applied to at least a part of the surface of the laminate 19. Typically, the pseudo reference electrode layer 19d is applied to the laminate in the pattern, the pattern resulting in a layer which comprises a blank area 19e which is surrounded by pseudo reference electrode material. The pseudo reference electrode layer may be applied by similar techniques to the working electrode layer.

Each electrode is typically printed, or otherwise coated, onto the relevant insulating layer in a chosen pattern. For the working electrode which is to be formed in the wall of the receptacle, the pattern selected should be such that at least a part of the electrode layer is exposed when hole 19d is created. Preferably the pattern chosen is such that the electrode layer is exposed around the whole perimeter of hole 19d. The electrode tracks may also be coated onto the insulating layer.

A hole is created in the laminate 19, typically through a part of the laminate which is not coated with counter electrode, i.e. in gap 19e. This has the advantage that when the hole is punched, counter electrode is not drawn onto the interior surface of the hole which ultimately forms the walls of the first portion of the receptacle.

The hole may be created by any suitable means. For example, the hole may be punched or drilled or formed by die-cutting, ultra-sonic cutting or laser drilling or a combination of these techniques (for example using the techniques described in GB 0413224.7 and GB 0413244.5 and the international application claiming priority therefrom, the contents of which are incorporated herein by reference in their entirety). This step has the advantage that the electrode surfaces are automatically cleaned by the action of creating the hole, thus reducing the requirement for a separate step of cleaning the electrodes.

A suitable technique for creating the hole is to punch the second part with a pneumatic or hydraulic press tool. Holes of 0.1 to 5 mm, preferably 0.5 to 1.5, more preferably about 1 mm diameter are preferred. The punching tool can be coated with hardening materials such as titanium and may or may not have an angled cutting edge. For example, the tool may be Ti coated with a 1° to 40°, preferably a 20° to 25° angle, or an alternative angle, from the horizontal cutting edge.

Where the strip comprises a receptacle rather than a partial receptacle, the laminate is bonded to a base, e.g. an insulating material 18 (Part B) to form the receptacle in which the insulating material 18 forms the base and the laminate 19 forms the walls. Bonding may be carried out by any suitable technique. For example, bonding may be performed using pressurized rollers. A heat sensitive adhesive may be used, in which case an elevated temperature is needed. Room temperature can be used for pressure sensitive adhesive.

If desired, air channels may be created at the joint between the base 18 and the laminate 19. This can be achieved, for example, by creating grooves in either the second surface of the laminate 19b or the surface of the base 18 prior to bonding these two parts together.

The step of printing the pseudo reference electrode layer to the laminate may be carried out either before or after creating the hole in the laminate and either before or after bonding the laminate to the insulating material.

After forming the receptacle, an electroactive substance as described above may be inserted into the receptacle, for example, using micropipetting or ink jet printing. The electroactive substance may then be dried by any suitable technique, for example air drying, freeze drying or oven baking.

If desired, a permeable or semi-permeable membrane 9 may then be placed over the receptacle (as in FIG. 2). Membrane structures are applied to the top surface of the device using, for example, double sided adhesive or screen printed pressure sensitive adhesive. Attachment of the membrane 9 may, for example, be carried out by using a pressure sensitive adhesive (which has been cast) that has been die cut to remove the adhesive in the area over the receptacle, typically over a wider working area such that the adhesive is located at a distance from the first open part 3.

Devices comprising two or more receptacles as described above can be produced by printing suitable patterns of working and pseudo reference electrode layers onto the insulating layers and creating two or more holes in the laminate 19 prior to bonding together the laminate 19 and the base 18.

The device of the invention can be used in an electrochemical sensing method by inserting a sample for testing into the or each receptacle, applying a potential between working and pseudo reference (or separate counter) electrodes and measuring the resulting electrochemical response. Typically, the current is measured. In this way, the device may be used for determining the content of various substances in the sample. The device may, for example, be used to determine the pentachlorophenol content of a sample for environmental assessment; to measure cholesterol, HDL, LDL and triglyceride levels for use in analysing cardiac risk, or for measuring glucose levels, for example for use by diabetics. A further example of a suitable use for the device of the invention is as a renal monitor for measuring the condition of a patient suffering from kidney disease. In this case, the device could be used to monitor the levels of creatinine, urea, potassium and sodium in the urine. The device can also be used to detect the presence of ischemia modified albumin in a blood or plasma sample.

The invention has been described above with reference to various specific embodiments. However, it is to be understood that the invention is not limited to these specific embodiments.

1. A device comprising an electrochemical cell, said device comprising a strip having at least one receptacle or partial receptacle formed therein, the receptacle or partial receptacle having a first open part in a first surface of the strip to enable a sample to enter the receptacle or partial receptacle,
wherein a working electrode of the electrochemical cell is in a wall or walls of the receptacle or partial receptacle, and
wherein a pseudo reference electrode of the electrochemical cell comprises a pseudo reference electrode layer formed on at least a part of the first surface of the strip.

2. A device according to claim 1, wherein the pseudo reference electrode layer substantially surrounds the first open part of the receptacle or partial receptacle.

3. A device according to claim 1, wherein the pseudo reference electrode layer is not in contact with the perimeter of the first open part of the receptacle or partial receptacle.

4. A device according to claim 3, wherein the pseudo reference electrode layer is at a distance of at least 0.2 mm from the perimeter of the first open part of the receptacle or partial receptacle, and/or at least a part of the pseudo reference electrode layer is no more than 1 mm from the perimeter of the first open part of the receptacle or partial receptacle.

5. A device according to claim 1, wherein the strip comprises at least one receptacle.

6. A device according to claim 1, wherein the working electrode has at least one dimension of less than 50 μm.

7. A device according to claim 1, wherein the ratio of the surface area of the pseudo reference electrode to the surface area of the working electrode is at least 3:1.

8. A device according to claim 1, wherein the receptacle or partial receptacle contains an electroactive substance, optionally in dried form.

9. A device according to claim 8, wherein the electroactive substance comprises an enzyme.

10. A device according to claim 1, wherein the first open part of the receptacle or partial receptacle is at least partially covered by a permeable or semi-permeable membrane.

11. A device according to claim 10, wherein the membrane is attached via attachment means to the first surface of the strip or to the pseudo reference electrode layer, wherein the attachment means substantially surrounds the first open part of the receptacle or partial receptacle and is at a distance of at least 0.2 mm from the perimeter of the first open part of the receptacle or partial receptacle.

12. A device according to claim 1, wherein the pseudo reference electrode acts as the counter electrode of the electrochemical cell.

13. A device according to claim 1, which device comprises a plurality of receptacles and/or partial receptacles, one or more of the receptacles and/or partial receptacles being as defined in claim 1.

14. (canceled)

15. A process for producing a device according to claim 1, which process comprises the steps of:
(a) forming a laminate comprising a working electrode layer between two layers of an insulating material;
(b) applying a pseudo reference electrode layer to at least a portion of a first surface of the laminate;
(c) creating a hole in the laminate; and optionally
(d) bonding a base to a second surface of said laminate to form a receptacle, wherein step (b) is carried out before or after steps (c) and/or (d).

16. A process according to claim 15, wherein the hole in the laminate does not pass through the pseudo reference electrode layer.

17. A process according to claim 15, wherein the pseudo reference electrode layer is applied to the laminate in a pattern, the pattern resulting in a layer comprising a blank area which is surrounded by pseudo reference electrode, and wherein the hole formed in step (c) passes through said blank area.

18. A process according to claim 15 which further comprises placing an electroactive substance as defined in claim 8 or 9 into the receptacle or partial receptacle and optionally drying the electroactive substance.

19. A process according to claim 15, which further comprises placing a membrane over at least a part of a first open part of the receptacle or partial receptacle.

20. A process according to claim 15, for producing a device as defined in claim 13, which process comprises creating two or more holes in said laminate.

21. An electrochemical sensing method comprising
inserting a sample into the receptacle or partial receptacle of a device according to claim 1;
applying a potential across the electrochemical cell; and
measuring the resulting electrochemical response.
